(19) United States
(12) Patent Application Publication
(10) Pub. No.: US 2006/0168626 A1
(43) Pub. Date: Jul. 27, 2006

(54) Methods and systems for providing video content to a mobile client

(75) Inventor: Jan Vorlicek, Prague 9 (CZ)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: U-Turn Media Corporation, Denver, CO (US)

(21) Appl. No.: 11/180,304

(22) Filed: Jul. 12, 2005

Related U.S. Application Data
(60) Provisional application No. 60/646,324, filed on Jan. 21, 2005.

(51) Int. Cl. H04N 7/16; H04N 7/173; H04N 7/18

(52) U.S. Cl. 725/62; 725/75; 725/109; 725/110

(57) ABSTRACT

Video content is provided from a mobile client from a server. The video content has at least a component provided by a format that is blocked on a transmission path from the server to the mobile client. The video content is intercepted. At least the component of the intercepted video content is packaged and inserted into a primary data transmission from the server to the mobile client. The primary data transmission has a format that is not blocked. This permits the mobile client to identify and unpackage the packaged component from the primary data transmission to recreate the video content.

### CROSS-REFERENCES TO RELATED APPLICATIONS

This application is a nonprovisional of, and claims the benefit of the filing date of, each U.S. Prov. Appl. No. 60/646,324, entitled “SYSTEM AND METHOD FOR STREAMING VIDEO DATA DELIVERY TO A MOBILE TERMINAL,” filed Jan. 21, 2005 by Jan Vorlicek, the entire disclosure of which is incorporated herein by reference for all purposes.

### BACKGROUND OF THE INVENTION

This application relates generally to client-server systems. More specifically, this application relates to a client-server system used for delivery of video content to mobile clients.

In recent years, there has been a significant increase in the use of handheld electronic devices. This increase has generally been coupled with steady technological advances that allow for increased processing power and greater memory, as well as the inclusion of more sophisticated software to operate the devices. These technological advances have allowed wireless service providers to seek innovative new functionalities that may be provided to attract increased market share.

One functionality that has generated interest among owners of handheld electronic devices is the streaming of multimedia to such devices. One example of multimedia that may be provided to such devices is motion video sequences that are streamed from a central content-delivery system to a mobile electronic device such as a mobile telephone, personal digital assistant, or the like. There are, however, a number of challenges that arise when faced with actual implementation of such capabilities. These challenges include the fact that existing networks or servers typically include a number of security measures, sometimes referred to in the art as software or hardware “firewalls.” The introduction of a data-transmission method, such as to support a streaming video format, often faces the difficulty that such security measures act to block transmission of these formats.

There is accordingly a general need in the art for improved methods and systems that accommodate such needs.

### BRIEF SUMMARY OF THE INVENTION

Methods and systems thus provide video content to a mobile client from a server. The video content has at least a component provided by a format that a mechanism comprised by a transmission path from the server to the mobile client is adapted to block. In a first set of embodiments, the video content is intercepted. At least the component of the intercepted video content is packaged and inserted into a primary data transmission from the server to the mobile client. The primary data transmission has a format that the mechanism is not adapted to block. This permits the mobile client to identify and unpackage the packaged component from the primary data transmission to recreate the video content.

The component may comprise a UDP format and the primary data transmission may comprise a TCP or HTTP format in different embodiments. The video content may be streamed video content or may be downloaded video content in different embodiments. In one embodiment, tags are inserted into the primary data transmission to identify the packaged component, permitting the mobile client to identify the packaged component from the tags.

In another set of embodiments, a primary data transmission is received from the server at the mobile client. The primary data transmission has a format that the mechanism is not adapted to block. A packaged component is identified in the primary data transmission. The packaged component is unpackaged. The video content is recreated with the component in the format from the unpackaged component. The recreated video content is displayed on the mobile client.

Again, the component may comprise a UDP format and the primary data transmission may comprise a TCP or HTTP format in different embodiments. The video content may also be streamed or downloaded content in different embodiments. The primary data transmission may also comprise tags that identify the packaged component so that the packaged component is identified by locating the tags within the primary data transmission.

The above methods may be embodied in a client-server system that comprises a server and a plurality of mobile clients. Each such mobile client is adapted to be carried by a user and to communicate wirelessly with the server such that video content is provided by the server to the mobile clients. The mobile clients and/or server may have a computer-readable storage medium that includes instructions to implement the methods described above.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sublabel is associated with a reference numeral and follows a hyphen to denote one of multiple similar components. When reference is made to a reference numeral without specification to an existing sublabel, it is intended to refer to all such multiple similar components.

FIG. 1 shows an overview of elements of a client-server system that may be used for delivery of multimedia in a mobile client environment;

FIG. 2A provides a schematic overview of a content-delivery system that may form part of the client-server system of FIG. 1;

FIG. 2B provides a schematic illustration of hardware components that may be included in mobile clients that form part of the client-server system of FIG. 1;

FIG. 3 provides a schematic illustration of the interaction of the server and mobile clients through a mobile network using translation proxies; and

FIG. 4 is a flow diagram summarizing methods for providing video content from the server to the mobile clients.

### DETAILED DESCRIPTION OF THE INVENTION

Embodiments of the invention provide methods and systems that provide video content to a mobile client from a server. References herein to “mobile clients” are intended to refer broadly to any wireless electronic device that has the capability of receiving content wirelessly. Examples of mobile clients include cellular telephones, personal digital assistants, and the like. Video content may be provided as downloaded content or as streamed content. “Streamed” content is content that is sent in a substantially continuous stream to a device and is played as it arrives; it is thus distinct from “downloaded” content which is fully downloaded to the device and played thereafter. Streamed content may be provided from prerecorded content files or may be distributed as part of a live broadcast feed. In a live broadcast, the content is usually converted to a compressed digital signal and transmitted in multicast fashion by streaming the same file to multiple user devices at substantially the same time.

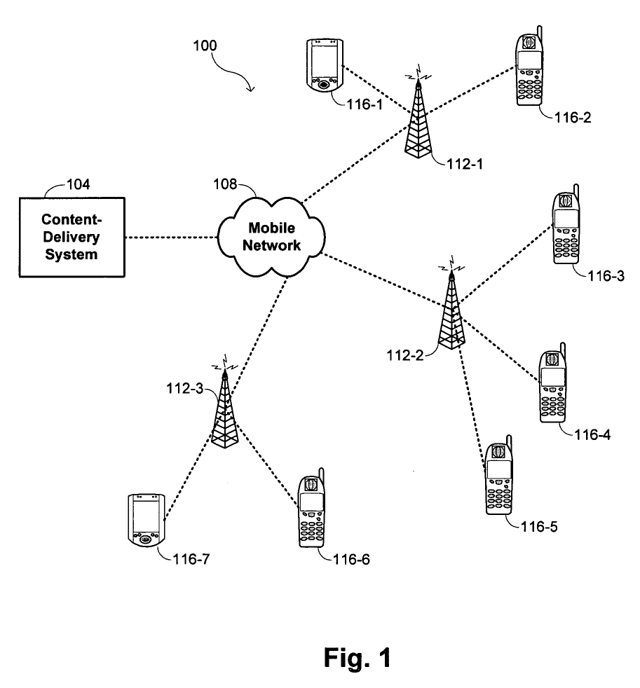

One physical arrangement that may be used to provide content to mobile clients is illustrated in FIG. 1. The client-server system 100 is implemented with a content-delivery system 104 that includes the server and a plurality of remote electronic devices 116 that correspond to the clients. Communications between the content-delivery system and the mobile clients may be effected through radio links, although other types of communications may be used in alternative embodiments. For instance, FIG. 1 shows an embodiment in which communications are made through a mobile network 108 that is itself in communication with a plurality of base stations 112 that are distributed geographically. This arrangement permits each mobile client 116 to communicate with the content-delivery system through one of the base stations 112 depending on the current physical location of the mobile client 116. It also permits the actual communications pathway used to change as the mobile client 116 changes position to move into closer proximity to a different one of the base stations.

The illustration in FIG. 1 emphasizes that the mobile clients may be different types of electronic devices, even in embodiments that use a single mobile network 108, by showing certain of the devices (116-2, 116-3, 116-4, 116-5, and 116-6) as cellular telephones and by showing other of the devices (116-1 and 116-7) as personal digital assistants. In other embodiments, a plurality of mobile networks 108 may interface with the content-delivery system 104. The communications links are shown as dotted lines in the drawing, with the exemplary embodiment illustrating an implementation in which all communications are performed through radio links or through other wireless forms of communication. It will be appreciated, however, that wire-based links may alternatively be used in some embodiments, with certain embodiments using a combination of wire-based and wireless communications. For instance, in one embodiment, the mobile network 108 might implement a wire-based interconnection of the base stations 112 with the content-delivery system, with communications between the base stations 112 and the mobile clients 116 still proceeding wirelessly.

The content that is to be provided to the mobile clients 116 may be stored by the content-delivery system 104, on a subsystem of the content-delivery system 104, or on another system in communication with the content-delivery system 104. The content is made available for access on a specific remote client 116 through a software application installed on the client 116 and configured to connect to the content-delivery system 104. With such a connection, the content is accessed from the content-delivery system 104 and presented to a user of the remote client 116 in a form suitable for that particular device.

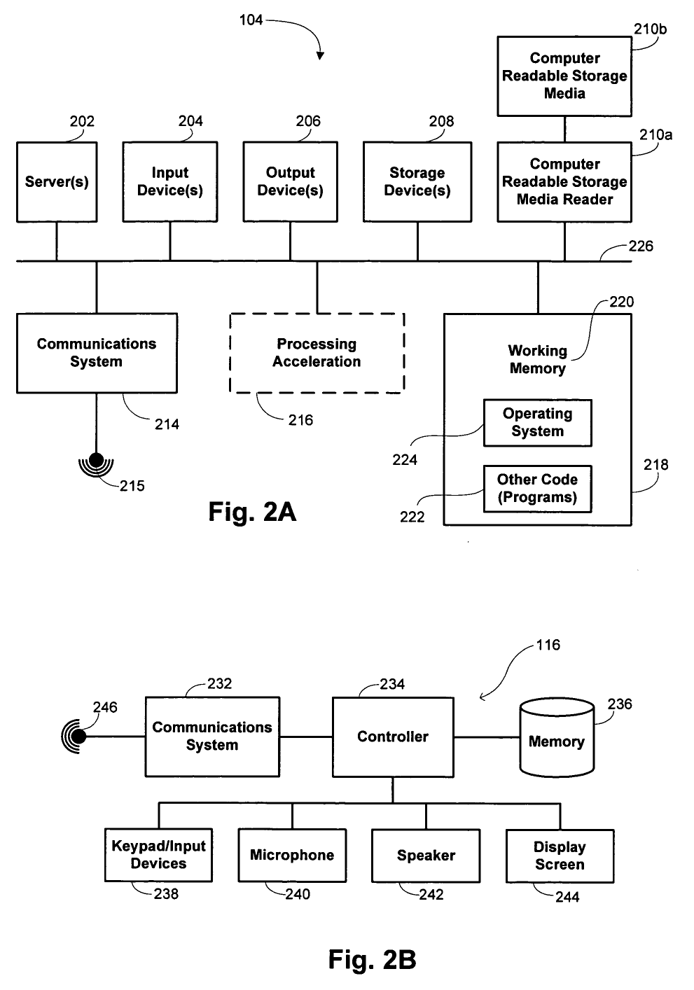

FIGS. 2A and 2B provide exemplary illustrations for structures that may be used by the content-delivery system 104 and by the clients 116 respectively in a particular embodiment. FIG. 2A broadly illustrates how individual system elements of the content-delivery system 104 may be implemented in a separated or more integrated manner. The content-delivery system 104 is shown comprised of hardware elements that are electrically coupled via bus 226, including a server 202, an input device 204, an output device 206, a storage device 208, a computer-readable storage media reader 210a, a communications system 214, a processing acceleration unit 216 such as a DSP or special-purpose processor, and a memory 218. The computer-readable storage media reader 210a is further connected to a computer-readable storage medium 210b, the combination comprehensively representing remote, local, fixed, and/or removable storage devices plus storage media for temporarily and/or more permanently containing computer-readable information. The communications system 214 may comprise a wired, wireless, modem, and/or other type of interfacing connection and permits data to be exchanged wirelessly through an antenna 215. The content may be stored on the storage device(s) 208.

The content-delivery system 104 also comprises software elements, shown as being currently located within working memory 220, including an operating system 224 and other code 222, such as a program designed to implement methods of the invention. It will be apparent to those skilled in the art that substantial variations may be used in accordance with specific requirements. For example, customized hardware might also be used and/or particular elements might be implemented in hardware, software (including portable software, such as applets), or both. Further, connection to other computing devices such as network input/output devices may be employed.

Operations of the mobile client 116 shown in FIG. 2B are coordinated by a controller 234. The controller is provided in communication with a memory 236 where data used to implement the controller functions may be stored, as well as where downloaded content may be stored. Communications may be received or transmitted wirelessly by an antenna 246 and processed by a communications system 232 provided in communication with the controller 234. The controller 234 may also coordinate other functionality of the mobile client 116. FIG. 2B illustrates an example where the mobile client 116 includes a keypad or other input devices 238, a microphone 240, a speaker 242, and a display screen 244, all of which are provided in communication with and under the control of the controller 234. Such components may be provided, for instance, in embodiments where the mobile client 116 comprises a cellular telephone, although additional components may also be provided in other embodiments.

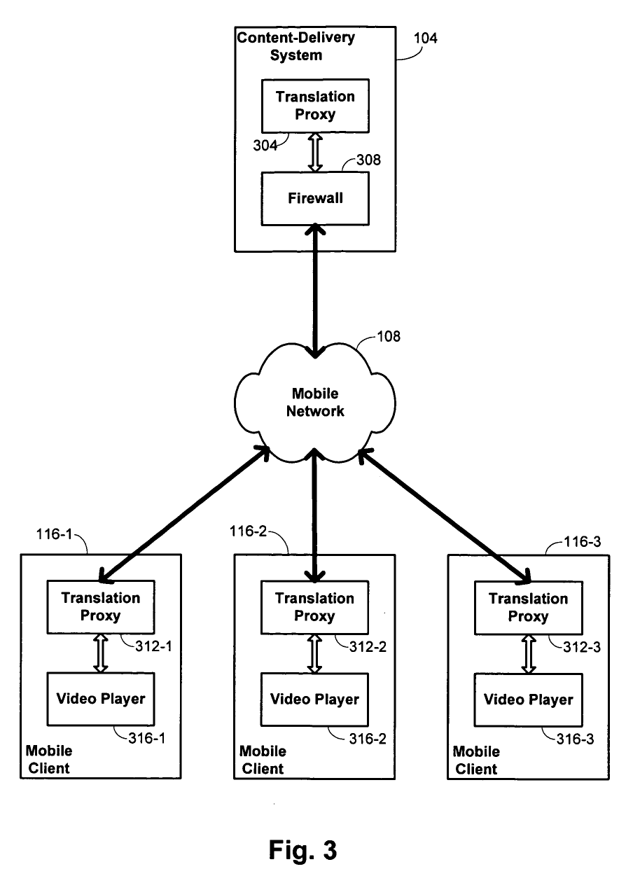

While FIGS. 2A and 2B provided illustrations of hardware structures for the content-delivery system 104 and the remote clients 116, FIG. 3 uses a more functional characterization. In FIG. 3, each of the mobile clients 116 is shown to comprise a video player 316. One suitable video player is the RealPlayer®, which is commercially available from Real Networks®, but the invention is not limited to any particular video player, and other suitable video players are available from alternative commercial sources. A selection of video segments are made available to the mobile clients 116 from the content-delivery system 104, with users of the mobile clients generally being able to select desired video segments for viewing on their respective mobile clients 116.

A transmission path between the content-delivery system 104 and each of the mobile clients 116 typically includes a variety of security measures, some of which may be incompatible with formats that form a component of the video content. For example, streaming video formats may use a User Datagram Protocol (“UDP”) for transmission of at least some of the data, but such transmission may be blocked by the configuration of the security measures. The mechanism from blocking transmission may generally be provided anywhere along the transmission paths, but is conveniently disposed at a point common to each of the paths to the various mobile clients 116. For example, the blocking mechanism may conveniently be disposed at the content-delivery system 104 or at the mobile network 108, often in the form of a firewall. FIG. 3 provides a specific example in which the blocking mechanism comprises a firewall 308 maintained at the content-delivery system 104, but such an example is intended to be illustrative rather than limiting.

One possible approach to addressing the blocking of UDP-protocol data by firewalls is to require that all security measures along the transmission paths between the content-delivery system 104 and the mobile clients 116 be reconfigured to permit the passage of UDP data. Such an approach may be commercially onerous and may weaken the security of the overall system. Embodiments of the invention accordingly use an approach in which the video-stream data are translated to a format that can safely be transmitted through the firewall, without the need to reconfigure the firewall to transmit the UDP data. The transmitted data may then be extracted and translated back to UDP format for use by the video player 316 in the mobile clients 116.

This is achieved in some embodiments of the invention by providing a thin proxy P_{M} 312 in each of the mobile clients 116 in communication with the video player 316, and optionally also including a corresponding proxy P_{S} in the content-delivery system. Both proxies P_{M} and P_{S} are configured for translation of the format that is restricted by the firewall 308 to a format that is not restricted and vice versa. For instance, in particular embodiments, the proxies P_{M} and P_{S} may be configured for translation between a RealMedia or 3GPP format and a format permissibly transmitted through the firewall 308. The translation may be performed by packaging the UDP component of the video stream and inserting it into the primary TCP or HTTP stream. One method for performing such packaging is described in ¶10.12 of the RFC2326 Real Time Streaming Protocol (RTSP), the entire disclosure of which is incorporated herein by reference for all purposes. Briefly, stream data are encapsulated by certain identification information and interleaved with binary data. In some embodiments, the video player 316 in a mobile client 116 communicates bidirectionally, in which case both proxies P_{M} and P_{S} may be configured both to encode and to decode the video-stream data.

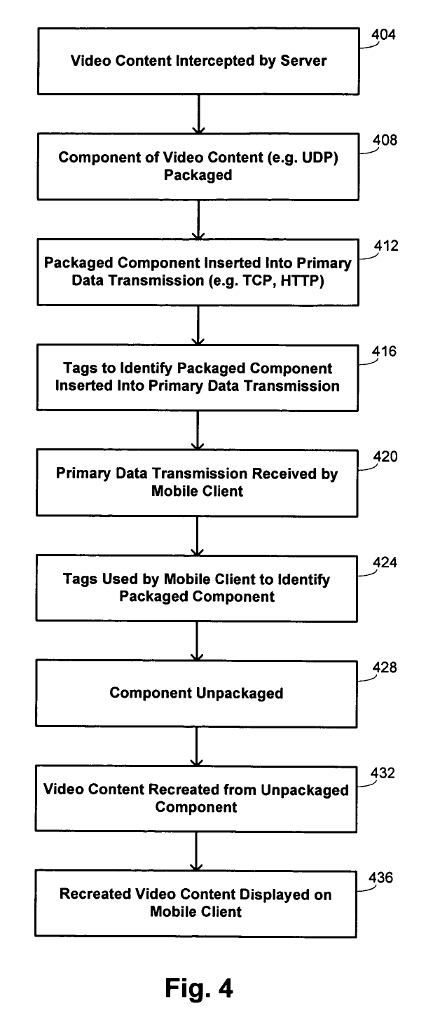

Methods for providing the video content to the mobile clients 116 are summarized with the flow diagram of FIG. 4. When data flow is in the direction from the content-delivery system 104 to a mobile client 116, the video content may be intercepted by the proxy P_{S} 304 at block 404, permitting the component that is ordinarily blocked over the transmission path, i.e. the UDP stream, to be packaged at block 408. This packaged component is inserted into the primary data transmission, which may be a TCP or HTTP transmission in different embodiments, at block 412. The packaged component may preferably be tagged at block 416 to simplify later identification of the tagged component.

The primary data transmission passes over the transmission path unhindered since the blocking mechanism is not adapted to block it, permitting the primary data transmission to be received by the mobile client at block 420. Upon receipt of the primary data transmission, the mobile-client proxy P_{M} 312 performs substantially the reverse process. That is, the proxy P_{M} 312 uses the tagging information in the transmission stream at block 424 to identify the packaged component. The component is unpackaged at block 428 so that the ordinarily blocked component, such as the UDP component, may be isolated. The video content is recreated from the unpackaged component at block 432, permitting the proxy P_{M} 312 to communicate the video content to the video player 316 using a protocol supported by the video player 316. In this way, the recreated video content may be displayed on the mobile client 116 at block 436 without needing to reconfigure the video player 316 to support the proxy P_{M} 312.

As previously noted, the proxy P_{S} 304 is optional. Depending on the configurability of the server 202 comprised by the content-delivery system 104, the server 202 may be configured to accept the primary data transmission directly. If the proxy P_{S} 304 is used, however, the server 202 generally communicates with the proxy P_{S} 304 using a protocol regularly supported by the server 202.

Thus, having described several embodiments, it will be recognized by those of skill in the art that various modifications, alternative constructions, and equivalents may be used without departing from the spirit of the invention. Accordingly, the above description should not be taken as limiting the scope of the invention, which is defined in the following claims.

What is claimed is:

1. A method of providing video content to a mobile client from a server, the video content having at least a component provided by a format that a mechanism comprised by a transmission path from the server to the mobile client is adapted to block, the method comprising:
intercepting the video content;
packaging at least the component of the intercepted video content; and
inserting the packaged component into a primary data transmission from the server to the mobile client, the primary data transmission having a format that the mechanism is not adapted to block,
whereby the mobile client may identify and unpackage the packaged component from the primary data transmission to recreate the video content.

2. The method recited in claim 1 wherein the component comprises a User Datagram Protocol (“UDP”) format.

3. The method recited in claim 1 wherein the primary data transmission comprises a Transmission Control Protocol (“TCP”) format.

4. The method recited in claim 1 wherein the primary data transmission comprises a HyperText Transfer Protocol (“HTTP”) format.

5. The method recited in claim 1 further comprising inserting tags into the primary data transmission to identify the packaged component, whereby the mobile client may identify the packaged component from the tags.

6. The method recited in claim 1 wherein the video content is streamed video content.

7. The method recited in claim 1 wherein the video content is downloaded video content.

8. A method of providing video content on a mobile client received from a server, the video content having at least a component provided by a format that a mechanism comprised by a transmission path from the server to the mobile client is adapted to block, the method comprising:
receiving a primary data transmission from the server at the mobile client, the primary data transmission having a format that the mechanism is not adapted to block;
identifying a packaged component in the primary data transmission;
unpackaging the packaged component;
recreating the video content with the component in the format from the unpackaged component; and
displaying the recreated video content on the mobile client.

9. The method recited in claim 8 wherein the component comprises a User Datagram Protocol (“UDP”) format.

10. The method recited in claim 8 wherein the primary data transmission comprises a Transmission Control Protocol (“TCP”) format.

11. The method recited in claim 8 wherein the primary data transmission comprises a HyperText Transfer Protocol (“HTTP”) format.

12. The method recited in claim 8 wherein:
the primary data transmission comprises tags that identify the packaged component; and
identifying the packaged component comprises locating the tags within the primary data transmission.

13. The method recited in claim 8 wherein the video content is streamed video content.

14. The method recited in claim 8 wherein the video content is downloaded video content.

15. A client-server system comprising:
a server; and
a plurality of mobile clients, each such mobile client being adapted to be carried by a user and to communicate wirelessly with the server such that video content is provided by the server to the mobile clients, the video content having at least a component provided by a format that a mechanism comprised by a transmission path from the server to the mobile clients is adapted to block,
wherein each such mobile client further has a computer-readable storage medium that includes:
instructions to receive a primary data transmission from the server, the primary data transmission having a format that the mechanism is not adapted to block;
instructions to identify a packaged component in the primary data transmission;
instructions to unpackage the packaged component;
instructions to recreate the video content with the component in the format from the unpackaged component; and
instructions to display the recreated video content on the each such mobile client.

16. The client-server system recited in claim 15 wherein the component comprises a User Datagram Protocol (“UDP”) format.

17. The client-server system recited in claim 15 wherein the primary data transmission comprises a Transmission Control Protocol (“TCP”) format.

18. The client-server system recited in claim 15 wherein the primary data transmission comprises a Hypertext Transfer Protocol (“HTTP”) format.

19. The client-server system recited in claim 15 wherein the server has a second computer-readable storage medium that includes:
instructions to intercept the video content;
instructions to package at least the component of the intercepted video content; and
instructions to insert the packaged component into the primary data transmission.

20. The client-server system recited in claim 15 wherein:
the second computer-readable storage medium further includes instructions to insert tags into the primary data transmission to identify the packaged component; and
the instructions to identify the packaged component comprise instructions to locate the tags within the primary data transmission.
